(19) United States
(12) Patent Application Publication
(10) Pub. No.: US 2009/0211647 A1
(43) Pub. Date: Aug. 27, 2009

(54) PRESSURE RELIEF VALVE HAVING A BURSTING DISK FOR A BEVERAGE DISPENSER

(76) Inventors: Ian Anderson, Cambridge (GB); Andrew R.B. Halket, Cambridge (GB)

Correspondence Address: Levy & Grandinetti, P.O. BOX 18385, Washington, DC, 20036, US

(21) Appl. No.: 11/597,099

(22) PCT Filed: May 20, 2005
(86) PCT No.: PCT/IB2005/001382

§ 371 Date: Mar. 4, 2009

(30) Foreign Application Priority Data
May 20, 2004 (GB) 0411295.9

(51) Int. Cl. F16K 17/14

(52) U.S. Cl. 137/68.23

(57) ABSTRACT

A valve assembly for filling a bag with a beverage under pressure has a valve body having a first passageway extending therethrough and a first valve seated in the first passageway for controlling the flow of beverage through the first passageway into and out of the bag. A pressure relief passageway extends through the valve body from inside the bag to within the container. A bursting disk is seated with the valve body normally closing the pressure relief passageway and is adapted to rupture permitting fluid to escape from the bag through the pressure relief passageway and into the container surrounding the bag when the pressure in the bag exceeds a predetermined pressure value.

### FIELD OF THE INVENTION

The present invention relates to an alcohol beverage container having a bag within the container and a bursting disk for relieving high pressure conditions between the bag and the container.

### BACKGROUND OF THE INVENTION

It is known to contain alcohol, such as wine in bags contained in a cardboard type container. Further, it is known to use a bag inserted into a keg for storing beer in the bag. In the case of a beer keg, pressure is applied to the bag to dispense the beer from the bag and out of the keg through a valve body assembly. Further, the bag is inserted into the keg container prior to the beer being filled into the bag through the valve body assembly.

During the step of filing the bag with beer, the beer is filled into the bag under pressure. As the bag expands, air contained within the container between the container wall and the bag escapes out through another valved opening in the container. Once the bag is filled with beer, the valves are closed. In some instances, if the bag has been overfilled, the carbonated beverage may continue to expand potentially creating a beer bomb. Accordingly, there is a need to provide a safety feature compensating for potential over pressurization of the bag.

### SUMMARY OF THE INVENTION

The present invention relates to a container adapted for a beverage under pressure, and preferably, an alcohol beverage. The container has a valve assembly extending therethrough secured with a bag to be filled with the alcohol beverage under pressure through the valve assembly. A pressure relief passageway extends through the valve assembly and a bursting disk normally closes the passageway. The bursting disk is adapted to rupture when the pressure in the bag exceeds a predetermined pressure value. The use of the bursting disk provides the advantage that should the pressure within the bag exceed a predetermined value, then the fluid contained within the bag, be it the alcohol beverage or gasses, is allowed to escape into the container.

In accordance with an aspect of the present invention there is provided a valve assembly adapted for filling a bag with a beverage under pressure where the bag is contained in a container and secured with the valve assembly. The valve assembly comprises a valve body adapted to be secured with the container. The valve body has a first passageway extending through the valve body. A first valve is seated in the first passageway for controlling the flow of beverage through the first passageway into and out of the bag. A pressure relief passageway extends through the valve body from inside the bag to within the container. A bursting disk is seated with the valve body normally closing the pressure relief passageway and is adapted to rupture permitting fluid to escape from the bag through the pressure relief passageway and into the container surrounding the bag when the pressure in the bag exceeds a predetermined pressure value.

In one embodiment, the valve body has a recessed disk shaped seat surrounding an opening of the pressure relief passageway and the bursting disk is seated in the recessed disk shaped seat.

In one embodiment, the bursting disk comprises a ring of double sided self adhesive material affixed on a first side to the recessed disk shaped seat. The busting disk has at least one membrane affixed to a second side of the ring so as to extend across the opening of the pressure relief passageway. The membrane bursts when the pressure in the bag exceeds the predetermined pressure value.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is a side sectional view of the keg;

FIG. 4 is an enlarged exploded view of the valve assembly shown in FIG. 3; and,

FIG. 5 is an enlarged sectional view of the bursting ring mounted in with the valve assembly.

### DETAILED DESCRIPTION OF THE INVENTION

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top in a kitchen. The front wall 12 is formed as an extension of two pivoting side walls 20 which may be moved between closed and open positions to allow the container or keg 22 (see FIG. 2 in broken lines) to be inserted into the housing of the home beer dispensing apparatus 10. The housing of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the dispensing apparatus 10. Alternatively, a 12 Volt DC supply input may be used.

The dispensing apparatus 10 has a cooling system 23 located behind and below keg 22 that is adapted to cool the keg 22 of beer when placed in dispensing apparatus 10. The dispensing apparatus 10 also dispenses the beer by providing a pressurized air supply (not shown).

Referring to FIG. 3, beer keg 22 has a general cylindrical shape with side walls 40 and a top wall or top portion 42 and a bottom wall or bottom portion 44. Both top wall 42 and bottom wall 44 are curved outwardly from the central portion of the keg 22 and are provided with a raised annular collar 46. The collars 46 provide additional support for the keg 22.

Mounted within the keg walls 40, 42 and 44 is a plastic bag 50 for containing an alcohol beverage which in the preferred embodiment is beer 52.

As shown in FIG. 3, the keg is filled with beer 52 within the bag 50 and as a result the bag 50 lines the inside walls of the keg 22. As the beer 52 is dispensed from the keg 22, an air pressure is established between the walls of the bag 50 and the inside surfaces of walls 40, 42 and 44 of the keg so as to provide pressure to the bag 50 allowing the beer 52 to be dispensed from the keg 22. The air pressure space is shown at 55.

The top portion 42 and collar 46 of the keg 22 has a keg dispensing device or valve assembly 60 extending through the top collar 46. The keg dispensing device 60 is connected to the tap 14 of the beer dispensing apparatus 10 by a tube or tap connection (not shown) extending from the keg dispensing device 60 at its top end 62.

The valve assembly 60 is connected with a dip tube 66 that extends into the keg 22 within bag 50 so as to provide a remote open end 64 adjacent the bottom portion of the keg for drawing beer 52 from the bottom portion of the keg 22. Beer 52 is drawn through open end 64, up hollow tube 66 out through the valve assembly 60 to the tap 14 (FIG. 1). For filling, the beer is inserted through valve assembly 60 down the tube 66 and out end 64 into bag 50. The dual direction flow of beer 52 into and out through valve assembly 60 is illustrated by arrows 67 in FIG. 3.

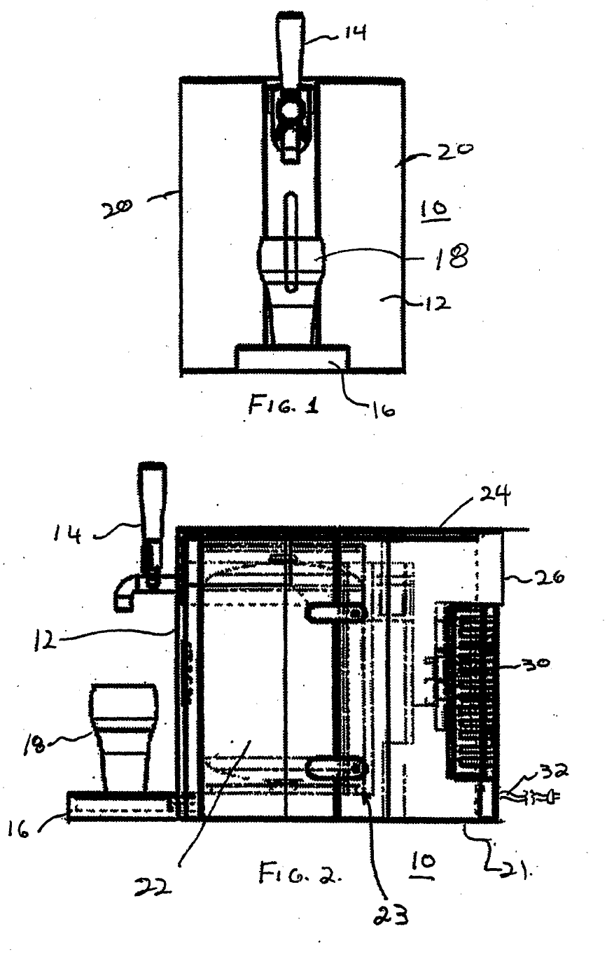

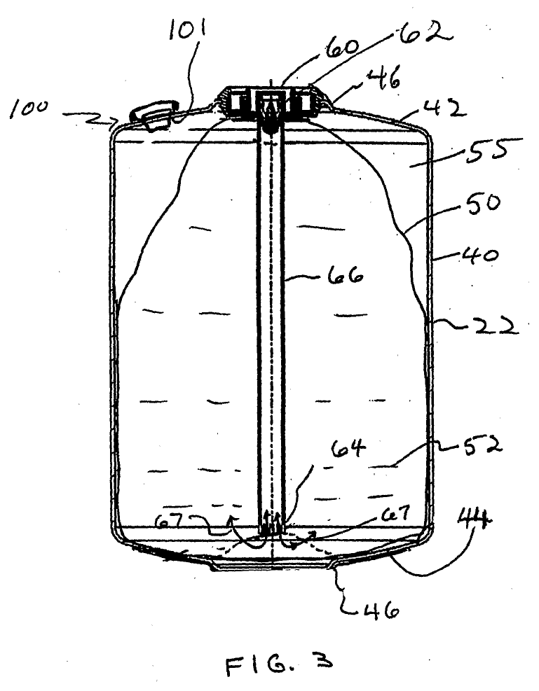

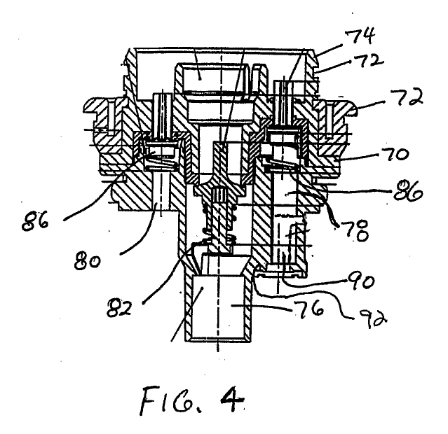

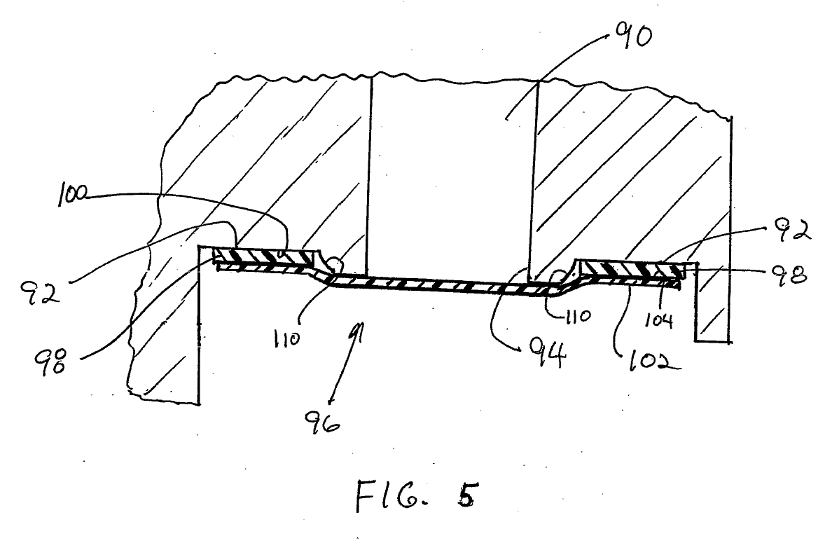

Referring now to FIG. 4, the valve assembly 60 is shown in more detail. The valve assembly 60 is adapted to fit into raised collar aperture 46 of keg 22. The valve assembly 60 has a valve body 70 that is secured within top collar 46 by bung 72. The valve body 70 has an annular groove 72 and flange 74 that is adapted to extend above the keg 22 for mating with a tap dispensing adapter (not shown) connected to tap 14.

The valve body 70 has a first passageway 76, a second passageway 78, and a third passageway 80 spaced apart from each other and extending through the valve body 70. The first passageway 76 is centrally disposed or located within the valve body 70 and the second and third passageways 78, and 80 are spaced radially of the first central passageway 76.

The valve assembly includes a first valve 82, a second valve 84 and a third valve 86. The first valve 84 is seated in the first passageway 76 for controlling the flow of the beverage or beer through the first passageway 76 into and out of the bag 50.

The second valve 86 is seated in the second passageway 78 for controlling the flow of gas such as carbon dioxide through the second passageway 78 into and out of the bag 50.

The third valve 86 is seated in the third passageway 80 and controls the flow of gas through the third passageway 52 into and out of the keg 22 exterior to the bag 50.

Referring to FIGS. 4 and 5, the valve body 70 has a pressure relief passageway 90 that extends through the valve body from inside the bag 50 to within the keg 22. This pressure relief passageway 90 is a separate passageway from the third passageway 78 and has been shown in dotted lines in FIG. 4.

The valve body 60 has a recessed disk shaped seat 92 surrounding an opening 94 (FIG. 5) of the pressure relief passageway 90.

Referring to FIG. 5, a bursting disk 96 is seated is seated in the recessed disk shaped seat 92 normally closing a pressure relief passageway. The bursting disk 96 comprises a ring of double sided self adhesive material 98 affixed on a first side 100 to the recessed disk shaped seat 92. The disk 96 further has at least one membrane 102 affixed to a second side 104 of the ring 98 so as to extend across the opening 94 of the pressure relief passageway 90. The membrane 102 preferably comprises a layer of polyvinylchloride plastic coated with aluminum foil. The membrane 102 bursts or ruptures when the pressure in the bag 50 exceeds the predetermined pressure value which is preferably 7 bar±10%. Upon rupture of the membrane 102, fluid escapes from the bag 50 through the pressure relief passageway 92 and into the keg 22 surrounding the bag 50.

The recessed disk shaped seat 92 has a rounded shoulder flange 110 surrounding the opening 94 of the pressure relief passageway 90 and the membrane 102 is stretched to curve over the rounded shoulder flange 110.

It should be understood that, while the keg 22 has been described in the illustrated embodiment for use with a beer appliance unit 10, the invention may be used in kegs and other beverage containers which may find use in applications other than in appliance units.

What is claimed is:

1. A valve assembly adapted for filling a bag with a beverage under pressure where the bag is contained in a container and secured with the valve assembly, the valve assembly comprising:
a valve body adapted to be secured with the container, the valve body having a first passageway extending through the valve body;
a first valve seated in the first passageway for controlling the flow of beverage through the first passageway into and out of the bag;
a pressure relief passageway extending through the valve body from inside the bag to within the container; and
a bursting disk seated with the valve body normally closing the pressure relief passageway and adapted to rupture permitting fluid to escape from the bag through the pressure relief passageway and into the container surrounding the bag when the pressure in the bag exceeds a predetermined pressure value.

2. The valve assembly of claim 1 wherein the valve body has a recessed disk shaped seat surrounding an opening of the pressure relief passageway and the bursting disk is seated in the recessed disk shaped seat.

3. The valve assembly of claim 1 wherein the predetermined pressure value is about 7 bar.

4. The valve assembly of claim 2 wherein the bursting disk comprises a ring of double sided self adhesive material affixed on a first side to the recessed disk shaped seat, and at least one membrane affixed to a second side of the ring so as to extend across the opening of the pressure relief passageway, and the membrane bursting when the pressure in the bag exceeds the predetermined pressure value.

5. The valve assembly of claim 4 wherein the recessed disk shaped seat has a rounded shoulder flange surrounding the opening of the pressure relief passageway wherein the membrane curves over the rounded shoulder flange.

6. The valve assembly of claim 5 wherein the membrane comprises a layer of polyvinylchloride plastic coated with aluminum foil.

7. The valve assembly of claim 2 wherein the valve body has a second passageway extending therethrough and a second valve seated in the second passageway for controlling the flow of a pressurizing gas through the second passageway into the container and exterior of the bag.

8. An alcohol beverage dispensing apparatus comprising:
a keg having an aperture;
a bag contained in the keg for containing an alcohol beverage; and,
a valve assembly to which the bag is secured and comprising:
a valve body secured in the aperture of the keg, the valve body having at least first and second spaced apart passageways extending through the valve body;
a first valve seated in the first passageway for controlling the flow of beverage through the first passageway into and out of the bag;
a second valve seated in the second passageway for controlling the flow of a pressurizing gas through the second passageway into the container and exterior of the bag;
a pressure relief passageway extending through the valve body from inside the bag to within the container; and
a bursting disk seated with the valve body normally closing the pressure relief passageway and adapted to rupture permitting fluid to escape from the bag through the pressure relief passageway and into the container surrounding the bag when the pressure in the bag exceeds a predetermined pressure value.

9. The apparatus of claim 8 wherein the valve body has a recessed disk shaped seat surrounding an opening of the pressure relief passageway and the bursting disk is seated in the recessed disk shaped seat.

10. The apparatus of claim 8 wherein the predetermined pressure value is about 7 bar.

11. The apparatus of claim 9 wherein the bursting disk comprises a ring of double sided self adhesive material affixed on a first side to the recessed disk shaped seat, and at least one membrane affixed to a second side of the ring so as to extend across the opening of the pressure relief passageway, and the membrane bursting when the pressure in the bag exceeds the predetermined pressure value.

12. The apparatus of claim 11 wherein the recessed disk shaped seat has a rounded shoulder flange surrounding the opening of the pressure relief passageway wherein the membrane curves over the rounded shoulder flange.

13. The apparatus of claim 12 wherein the membrane comprises a layer of polyvinylchloride plastic coated with aluminum foil.
